(19) United States
(12) Patent Application Publication
(10) Pub. No.: US 2013/0113606 A1
(43) Pub. Date: May 9, 2013

(54) Passive Wireless Article with Passcode Touch Sensor Array

(71) Applicants: Donna R. Etheridge, Raleigh, NC (US); Kumar B. Kori, Cary, NC (US); Richard W. Vanderpool, III, Raleigh, NC (US); David R. Wishum, Cary, NC (US)

(72) Inventors: Donna R. Etheridge, Raleigh, NC (US); Kumar B. Kori, Cary, NC (US); Richard W. Vanderpool, III, Raleigh, NC (US); David R. Wishum, Cary, NC (US)

(73) Assignee: INTERNATIONAL BUSINESS MACHINES CORPORATION, Armonk, NY (US)

(21) Appl. No.: 13/291,406

(22) Filed: Nov. 8, 2011

(51) Int. Cl. G06K 7/01

(52) U.S. Cl. 340/10.1

(57) ABSTRACT

Mechanisms are provided, in a portable wireless device, for enabling transmission of stored data from the portable wireless device. The portable wireless device receives an interrogation signal requesting that the portable wireless device transmit stored data. The portable wireless device detects, in response to receiving the interrogation signal, a pattern of activated touch sensors on the portable wireless device activated at approximately a same time. The portable wireless device compares the detected pattern of activated touch sensors to a required pattern of activated touch sensors. The portable wireless device transmits the stored data in response to the detected pattern of activated touch sensors matching the required pattern of activated touch sensors.

### BACKGROUND

The present application relates generally to an improved data processing apparatus and method and more specifically to a wireless article with passcode touch sensor array.

Many wireless devices are in wide use in today's society. Wireless telephone devices, wireless computers, and the like, utilize cellular, satellite, or WiFi communication systems to communicate with other devices. Other types of wireless communication are also available that allow communication devices to communicate at more limited ranges including Bluetooth communication. Other devices, such as smart cards, toll tags, and the like, utilize radio frequency identifier (RFID) communication. RFID communication is a technology that uses radio waves to transfer data from an electronic tag, referred to as an RFID tag or label, attached to an object, through a reader for the purpose of identifying and/or tracking the object. The tag's information is stored electronically.

The RFID tag includes a small radio frequency (RF) transmitter and receiver. An RFID reader transmits an encoded radio signal to interrogate the tag. The tag receives the message and responds with its identification information. Many RFID tags do not use a battery. Instead, the tag uses the radio energy transmitted by the RFID reader as its energy source. A RFID system is design so that it may discriminate several tags that might be within the range of the RFID reader.

RFID enabled credit cards and other articles that store personal information that is transmitted using an RFID mechanism, are susceptible to inadvertent of unwanted interrogation of the articles. In such cases, personal information, credit card information, and the like may be transmitted to RFID readers without the owner or user of the RFID enabled article knowing that the transmission is occurring and without the owner or user's permission. This allows thieves to utilize such information since no signature is typically required for small value transactions. That is, the thief may obtain the information from the RFID enabled article using their own RFID reader, and may then utilize that information in other transactions without the knowledge of the owner or user of the RFID enabled article and thereby access credit card accounts, bank accounts, or the like, of the owner/user. Unless a cashier or other person engaged in the transaction checks the identification, e.g., driver's license, of the person offering the personal information to ensure that the person offering the personal information is indeed an authorized person to provide the personal information, then the theft may go unnoticed until the charges for the transaction appear on the owner/user's statements, which may be too late to apprehend the thief.

### SUMMARY

In one illustrative embodiment, a method, in a portable wireless device, for enabling transmission of stored data from the portable wireless device. The method comprises receiving, by the portable wireless device, an interrogation signal requesting that the portable wireless device transmit stored data. The method further comprises detecting, by the portable wireless device, in response to receiving the interrogation signal, a pattern of activated touch sensors on the portable wireless device activated at approximately a same time. The method further comprises comparing, by the portable wireless device, the detected pattern of activated touch sensors to a required pattern of activated touch sensors. In addition, the method comprises transmitting, by the portable wireless device, the stored data in response to the detected pattern of activated touch sensors matching the required pattern of activated touch sensors.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a passive wireless article in accordance with one illustrative embodiment;

FIG. 2 is an example block diagram illustrating the primary operational elements of a passive wireless article in accordance with one illustrative embodiment; and

FIG. 3 is a flowchart outlining an example operation for utilizing a passive wireless article in accordance with one illustrative embodiment.

### DETAILED DESCRIPTION

To address the problem of inadvertent transmission of personal information from RFID enabled articles, such as RFID credit cards, bank cards, and the like, various security techniques have been developed. In one technique, described in U.S. Patent Application Publication No. 2010/0277320, the RFID article has a RFID keypad provided on the RFID article such that when a key on the RFID keypad is pressed by the user, the corresponding value is transmitted to an RFID reader device. In this way, the RFID keypad may be used by the user to transmit information, one key at a time, for the purpose of confirming an identity of the user, controlling an object, or requesting a service.

The technique described in U.S. Patent Application Publication No. 2010/0277320 is essentially to provide a wireless keypad. Thus, when a user presses a key on the RFID keypad, the RFID article transmits the corresponding value immediately to the RFID reader. Security operations are still performed in a centralized information processing system external to the RFID article.

A similar technology is described in U.S. Patent Application Serial No. 2009/0159705. With this technology, buttons are provided on a card to perform activities that would otherwise be performed at an ATM, payment card reader, or by a person, such as entering an amount of a transaction, entering a PIN, or the like. Again, security operations, transaction operations, and the like, are all performed by a separate centralized computing mechanism rather than in the card itself.

In another technology, described in WO 2011/002178, a RFID card is provided with a built-in electric switch. The RFID card transmits data to/from a reader when a finger contacts the electrical switch. The RFID chip in the RFID card calculates data to be transmitted/received when the electrical switch is disconnected. A similar mechanism is described in UK Patent Application GB 2444098 which provides both a mechanical and electrical switch mechanism for a RFID card.

While these mechanisms provide an ability to control when a RFID card transmits data, they are simply on/off switches that provide little in terms of security. Anyone who has possession of the RFID card may enable the transmission of personal information from the RFID card simply by placing their finger on the electric switch or manipulating the mechanical switch. Thus, an unauthorized user may obtain possession of the RFID card and use it to transmit personal information of the actual owner/authorized user of the RFID card simply by pressing the electric/mechanical switch. Furthermore, the owner/authorized user may inadvertently press the electric/mechanical switch and inadvertently enable transmission of data from the RFID card.

Still further, other technologies, such as described in WO 2009/096767, allow one to use biometric information to gain access to data stored on a flash memory, security token, smart card, etc. That is, a fingerprint reader may be incorporated on the flash memory, security token, smart card, etc., such that the user's fingerprint is read and compared against fingerprint data stored in the device. While this mechanism provides added security, it requires a relatively expensive fingerprint reader device to be incorporated into the device and a relatively complex software mechanism for comparing read fingerprint data to stored fingerprint data. Furthermore, such comparisons are not always accurate and discrepancies between a user's read fingerprint and stored fingerprint may be detected falsely based on the orientation of a user's finger, sensitivity of the reader device, and many other factors.

The illustrative embodiments provide a mechanism for solving the deficiencies of these known mechanisms by providing a passive wireless device, such as an RFID tagged device, wireless enabled smart cards, or the like, that comprises a plurality of touch sensor pads that detect the presence of a user's fingers over or pressing the touch sensor pads. The article of the illustrative embodiments is referred to as a “passive wireless” article or device herein because the article/device exists in an unpowered or passive state until energized by the energy of a received electromagnetic signal. For example, the passive wireless article may be a RFID tagged article/device that uses the received electromagnetic signal as the power source for energizing the internal circuitry of the RFID tagged article/device.

With the mechanisms of the illustrative embodiments, a user is required to place his/her fingers over a combination of the touch sensor pads at approximately a same time to thereby generate a pattern of activated touch sensor pads used to enable the operation of the passive wireless device with regard to transmitting personal information data form the passive wireless device to an external reader device. That is, the user must place his/her fingers over a correct combination of a plurality of the touch sensor pads, that is less than a total number of touch sensor pads provided on the passive wireless device, at substantially the same time. Thus, some touch sensor pads will detect the presence of the user's fingers and other touch sensor pads will not detect the presence of a user's finger. The particular combination of touch sensor pads detected within a time period after energization by a received electromagnetic signal, such as a radio frequency signal or the like, may be compared to a previously stored combination of touch sensor pad detections/non-detections that is indicative of an authorized user attempting to utilize the passive wireless device. If there is a match between the combinations, then the passive wireless device is enabled for transmission of personal information data from the passive wireless device to a reader device.

The mechanisms of the illustrative embodiments improve upon the known mechanisms that utilize a single switch to enable transmission of personal information data in that the illustrative embodiments require a user to know the particular combination of touch sensor pads that is required to enable the transmission of the personal information data. Thus, only authorized users are able to access the personal information data stored on the passive wireless article/device and unauthorized users who do not know the particular combination of touch sensor pads to touch will not be able to access the personal information data stored in the passive wireless article/device.

The mechanisms of the illustrative embodiments improve upon the known mechanisms that provide wireless keypads on a card in that the illustrative embodiments do not permit any transmission from the passive wireless article/device until the entered combination of touch sensor pads is authenticated. Furthermore, the authentication of the entered combination of touch sensor pads is performed within the passive wireless article/device itself and does not require an authentication mechanism in a separate device/system.

The mechanisms of the illustrative embodiments further improve upon known mechanisms that utilize a biometric sensor to enable access to the stored information in a device in that a simplified and less costly mechanism is provided that still provides a high degree of security. Moreover, the mechanisms of the illustrative embodiments are less susceptible to false detections of discrepancies in the user input and the stored required data.

FIG. 1 is an example diagram of a passive wireless article in accordance with one illustrative embodiment. As shown in FIG. 1, the passive wireless article 100 comprises a body 110 which may be constructed of any suitable material to house electronic devices for storing data, receiving wireless signals, transmitting wireless signals, and performing authentication operations as described hereafter. Such materials may include plastic materials, metal materials, paper materials, and the like. The housing 110 may further comprise identification markings 120 on the exterior of the housing 110, such as an account number, photo identification, issuing organization, expiration date, issue date, or the like.

In accordance with the mechanisms of the illustrative embodiments, the housing 110 further comprises a plurality of touch sensors 130 for detecting the presence of a user's fingertips over the touch sensors 130. The touch sensors 130, represented as circular pads in the depiction but not being limited to such, may be of any of a plurality of different types. For example, the touch sensors 130 may be depressable switches that detect the presence of the user's fingertips when the user's fingers depress the touch sensors 130, e.g., bump pads on the surface of the housing 110 that are flexible such that pressure from a user's fingertips will depress the bump pads causing a switch connection to be established. The touch sensors 130 may alternatively be of a heat sensing type that senses the body heat of the user's fingertips, may be of a touch display type sensor in which an electrical connection is generated through the user's fingertip, or the like. Any type of sensor that is able to detect the presence of a user's fingertip over the sensor may be used without departing from the spirit and scope of the illustrative embodiments.

With the mechanisms of the illustrative embodiments, when a user wishes to enable the passive wireless article 100 to transmit stored personal information, such as a credit card number, personal identification number, other account information, personal identification information, security codes, an authorization message, or any other type of data used to complete an operation, transaction, or the like, with an external reader device, the user must place his fingertips over a correct combination of the touch sensors 130 on the housing 110 of the passive wireless article 100, press the touch sensors 130 to close a switch, or otherwise activate a correct combination of the touch sensors 130, i.e. a correct subset of the touch sensors 130, while not activating another subset of the touch sensors 130. Only when an appropriate interrogation signal is received by the passive wireless article 100, e.g., a radio frequency interrogation sensor that may be used to energize the internal circuitry of the passive wireless article 100, and the user of the passive wireless article 100 provides a correct input via the touch sensors 130 by activating the correct subset of touch sensors 130 while not activating the a second subset of touch sensors 130, will the passive wireless article 100 be enabled to transmit stored data in the passive wireless article 100.

It should be appreciated that the depiction in FIG. 1 is only exemplary and is not intended to state or imply any limitation on the particular configuration, size, shape, organization, or even type of the passive wireless article 100. That is, rather than taking the form of a card type of article as shown, e.g., a credit card, identification card, smart card, or the like, the passive wireless article 100 may take many other different forms. For example, the passive wireless article 100 may take the form of a flexible armband, a wristband, a label, packaging material, or the like. The passive wireless article 100 may have many different shapes including a rectangular shape as shown, circular, triangular, or any other shape suitable to the particular implementation.

In addition, the configuration of the touch sensors 130 are not limited to an array of touch sensors 130 having rows and columns as depicted in FIG. 1. To the contrary, the touch sensors 130 may be configured on the housing 110 of the passive wireless article 100 at positions convenient for placement of fingertips as well as make it difficult for a non-authorized user to guess the particular correct combination of touch sensors 130. For example, if the touch sensors 130 are placed at seemingly random locations on the housing 110, it may make it more difficult for a non-authorized user to discern a probable correct combination of touch sensors 130. In other embodiments, the touch sensors 130 may be configured along an outer edge of one side of the housing 110, at corners of one side of the housing 110, on both sides of the housing 110, i.e. a back side and a front side of the housing 110, or the like. Preferably, the touch sensors 130 are configured to have sufficient spacing between the touch sensors 130 to permit a user's fingertip to activate one touch sensor 130 without necessarily activating nearby touch sensors 130.

In one embodiment, the touch sensors 130 may be a multi-touch sensing display mechanism, such as may be found in smart phones, personal digital assistants, and other portable electronic devices. In fact, while the present invention is primarily described with regard to passive wireless devices 100, the mechanisms of the illustrative embodiments may further be applicable to more active wireless devices, such as smart phones, personal digital assistants, portable computers, and the like.

In either case, whether passive or active, the multi-touch sensing display mechanism may detect the presence of a user's fingertips at various locations on the multi-touch sensing display. The detected locations on the display may be compared against stored locations for a correct combination of locations for activating the transmission of data from the wireless device. If the user's fingertips are placed in locations that correspond to the correct combination of locations, within a given tolerance, then the wireless device is activated for transmissions. Alternatively, in one illustrative embodiment, the combination of locations may be relative locations, such that as long as the detected placement of the fingertips on the multi-touch sensing display have a pattern relative to one another, regardless of the particular location of the individual fingertip placements, then a correct combination of locations is detected and the wireless device is enabled for transmission of stored information/data, i.e. the particular orientation of the pattern and particular portion of the display in which the fingertips are detected is not important as long as the relative distances between the detected fingertip positions in both a first dimension and a second dimension, e.g., x and y axis, match those of a correct combination within a given tolerance.

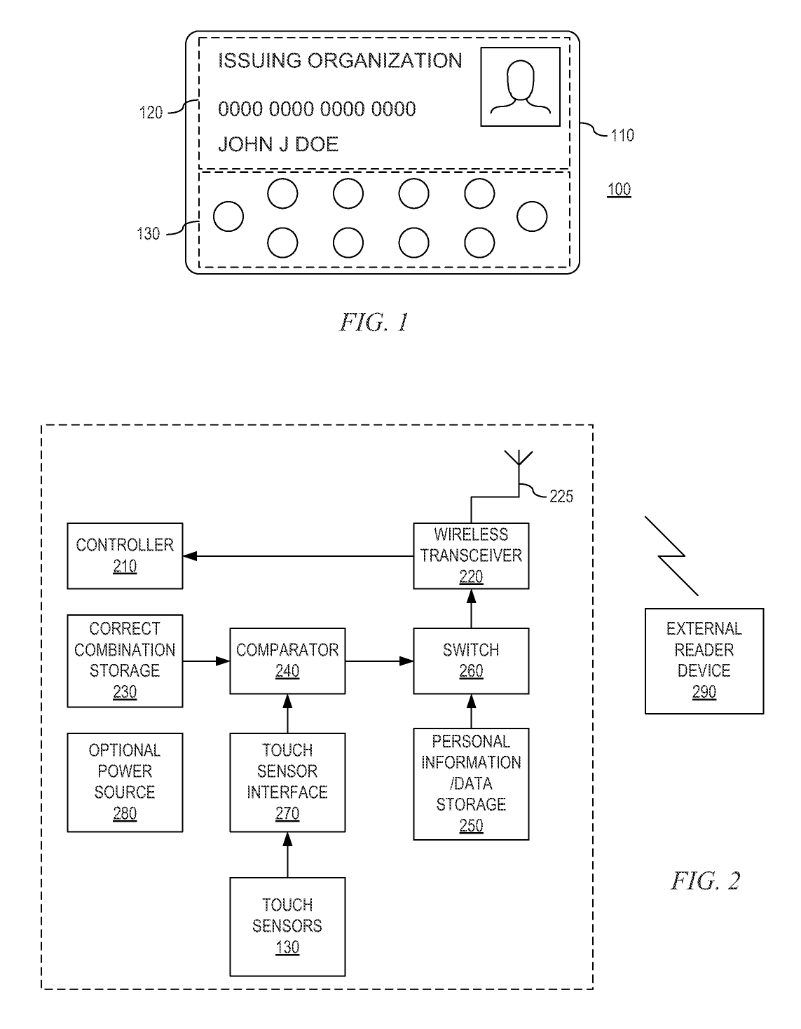

FIG. 2 is an example block diagram illustrating the primary operational elements of a passive wireless article in accordance with one illustrative embodiment. FIG. 2 illustrates the primary internal operational elements of a passive, or active, wireless device 200 that are used to perform communication of personal information/data. These primary operational elements may be implemented, for example, as circuitry and hardware logic within the wireless device 200.

As shown in FIG. 2, the primary operational elements include a controller 210, a wireless transceiver 220, a correct combination storage device 230, a comparator 240, a personal information/data storage device 250, a switching mechanism 260, a touch sensor interface 270, and an optional supplementary power source 280. The controller 210 controls the overall operation of the wireless device 200 and orchestrates the operation of the other components of the wireless device 200. The wireless transceiver 220 is coupled to an antenna 225 through which an external signal is received from an external reader device 290. For a passive wireless device 200, the external signal is both an interrogation signal from the external reader device 290 and a source of power for the internal circuitry of the wireless device 200 including the components shown in FIG. 2. For example, in one illustrative embodiment, the wireless transceiver 220 may utilize a radio frequency identifier (RFID) mechanism to utilize the energy of the received signal as a source of power to energize the circuitry of the other elements for a short amount of time. However, even though the circuitry of the other elements of the wireless device 200 may be energized by the received signal, the wireless device 200 is not yet permitted to transmit data to the external reading device 290.

When the wireless device 200 is first initialized, a user may enter an appropriate user selected combination of touch sensor activations that will allow the wireless device 200 to be enabled for transmission of personal information/data from the wireless device 200 to an external reader device 290. This user selected correct combination of touch sensor activations is stored in the correct combination storage device 230 for later use in comparing user activations of touch sensors to determine if a user has activated a correct combination of touch sensors to enable transmission of personal information/data from the wireless device 200.

When a user wishes to have the personal information/data stored in the personal information/data storage device 250 of the wireless device 200 transmitted to the external reader device 290 via the wireless transceiver 220, the user places his/her fingertips over a particular combination of the touch sensors 270 at substantially the same time. The touch sensors 270 are energized by the received interrogation signal from the external reader device 290 and thus, are able to detect the user's fingertips being in proximity to the touch sensors 270 or otherwise activating the touch sensors 270. Thus, the enablement of the wireless device 200 for transmission of stored information/data is dependent upon both the receiving of an interrogation signal from an external reader device 290 and the user entering a correct combination of touch sensor inputs via the touch sensors 270.

In response to detecting the activation of one or more of the touch sensors 270, the inputs from the touch sensors 270 are compared, by comparator 240, to the correct combination of touch sensor inputs stored in the correct combination storage device 230. If the touch sensor input that is currently being received matches the correct combination of touch sensor inputs stored in the correct combination storage device 230, then the comparator 240 outputs a signal to the switching mechanism 260 that enables output of the stored information/data in the personal information/data storage device 250 to the wireless transceiver 220. The stored information/data is then transmitted by the wireless transceiver 220 to the external reader device 290. If the touch sensor input that is currently being received does not match the correct combination of touch sensor inputs, then the signal is not sent to the switching mechanism 260 and the stored information/data is not transmitted by the wireless transceiver 220.

In some illustrative embodiments, optional supplementary power source 280 may be provided to provide additional power to enable operation of the touch sensors 270 and other circuitry within the wireless device 200. However, the wireless transceiver 220 may be configured such that it is not powered by the optional supplementary power source and thus, requires the reception of an interrogation signal from the external reader device 290 to be powered and able to transmit the stored information/data. In this way, additional power is made available for the circuitry in cases where the interrogation signal may not be sufficient to power all of the circuitry of the wireless device 200 required to perform the operations of the illustrative embodiments, but still requiring the reception of the interrogation signal before transmission of stored information/data is made possible.

In yet other illustrative embodiments, as mentioned above, the wireless device 200 may be an active wireless device, such as a smart phone, personal digital assistant, portable computer, or the like. As such, software mechanisms may be used to implement various ones of the components set forth in FIG. 2. For example, a software mechanism may be used to perform the functionality of the comparator 240 and switching mechanism 250. Thus, software may compare the received inputs from touch sensors 270 to stored data indicative of a correct combination of touch sensors for enabling transmission of stored information/data. In response to the comparator 240 software determining that there is a match between the received inputs form the touch sensors 270 and the stored correct combination of touch sensor inputs, a functionality of the transceiver 220 may be enabled through software mechanisms to transmit the stored information/data.

Thus, the illustrative embodiments provide mechanisms by which unauthorized transmission of stored personal information/data is minimized. The illustrative embodiments require that the user attempting to transmit the stored personal information/data in the wireless device know the correct combination of touch sensors to activate at a same time, to thereby enter a pattern of touch sensor inputs, in order to enable the transmission. Thus, not just anyone having possession of the wireless device can gain access to the stored personal information/data. Only authorized persons knowing the correct combination can access the stored personal information/data. The mechanisms of the illustrative embodiments are still less complicated and costly than biometric based mechanisms and less prone to false detections if differences between inputs and required inputs for access to the stored information/data.

As will be appreciated by one skilled in the art, aspects of the present invention may be embodied as an apparatus, system, method, or computer program product. Accordingly, as mentioned above, aspects of the present invention may take the form of an entirely hardware embodiment or an embodiment combining software (including firmware, resident software, micro-code, etc.) and hardware aspects that may all generally be referred to herein as a “circuit,” “module” or “system.” Furthermore, aspects of the present invention may take the form of a computer program product embodied in any one or more memories having computer usable program code embodied thereon. Any combination of one or more memories may be utilized to store the computer usable program code including a random access memory (RAM), a read-only memory (ROM), an erasable programmable read-only memory (EPROM or Flash memory), or the like.

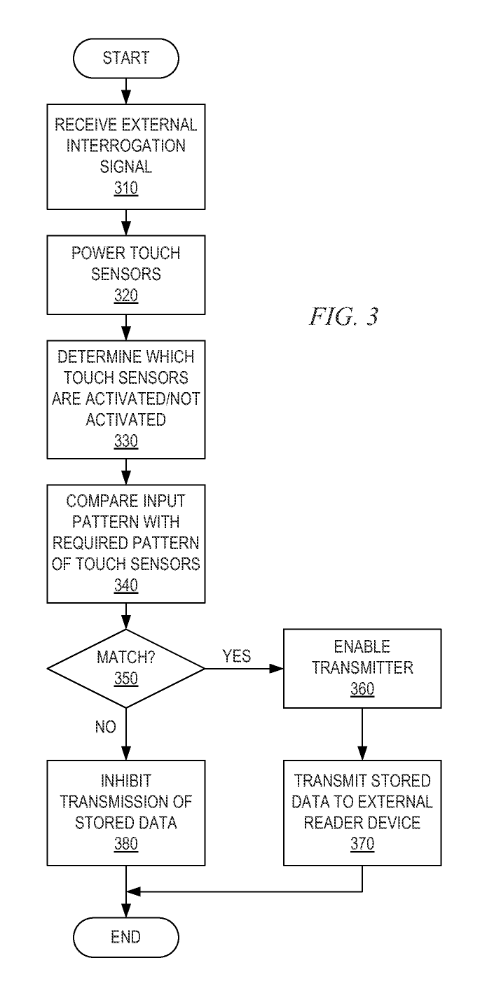

Aspects of the present invention are described herein with reference to the flowchart illustration in FIG. 3 and the block diagrams of FIGS. 1-2 above, with regard to methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, passive/active wireless device, or other programmable data processing apparatus to produce a machine, such that the instructions, which execute via the processor of the computer, passive/active wireless device, or other programmable data processing apparatus, create means for implementing the functions/acts specified in the flowchart and/or block diagram block or blocks.

These computer program instructions may also be stored in a memory that can direct a computer, passive/active wireless device, other programmable data processing apparatus, or other devices to function in a particular manner, such that the instructions stored in the memory produce an article of manufacture including instructions that implement the function/act specified in the flowchart and/or block diagram block or blocks.

The computer program instructions may also be loaded onto a computer, a passive/active wireless device, other programmable data processing apparatus, or other devices to cause a series of operational steps to be performed on the computer, passive/active wireless device, other programmable apparatus, or other devices to produce a computer implemented process such that the instructions which execute on the computer, passive/active wireless device, or other programmable apparatus provide processes for implementing the functions/acts specified in the flowchart and/or block diagram block or blocks.

The flowchart and block diagrams in the figures illustrate the architecture, functionality, and operation of possible implementations of apparatus, systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 3 is a flowchart outlining an example operation for utilizing a passive wireless article or device in accordance with one illustrative embodiment. As shown in FIG. 3, the operation starts with receiving an interrogation signal from an external reader device (step 310). Touch sensors associated with the passive wireless article are powered (step 320) and a determination is made as to which touch sensors are activated by the presence of a user's fingertips, and which touch sensors are not activated by the presence of the user's fingertips (step 330). The pattern of activated touch sensors is compared to a stored pattern of touch sensors required to enable transmission of stored information/data (step 340). A determination is made as to whether there is a match between the received pattern of activated touch sensors and the stored required pattern of touch sensor activations (step 350). If so, then the transmission of the stored information/data is enabled (step 360) and the stored information/data is transmitted to the external reader device from which the interrogation signal was received (step 370). If there is not a match, then the transmission is inhibited (step 380). The operation then terminates.

As noted above, it should be appreciated that the illustrative embodiments may take the form of an entirely hardware embodiment or an embodiment containing both hardware and software elements. In one example embodiment, the mechanisms of the illustrative embodiments are implemented as circuitry and hardware logic in a wireless device. In other illustrative embodiments, various components of the illustrative embodiments are implemented in software or program code, which includes but is not limited to firmware, resident software, microcode, etc.

An apparatus/system suitable for storing and/or executing program code will include at least one processor coupled directly or indirectly to memory elements. The memory elements can include local memory employed during actual execution of the program code, bulk storage, and cache memories which provide temporary storage of at least some program code in order to reduce the number of times code must be retrieved from bulk storage during execution.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a portable wireless device, for enabling transmission of stored data from the portable wireless device, comprising:
receiving, by the portable wireless device, an interrogation signal requesting that the portable wireless device transmit stored data;
detecting, by the portable wireless device, in response to receiving the interrogation signal, a pattern of activated touch sensors on the portable wireless device activated at approximately a same time;
comparing, by the portable wireless device, the detected pattern of activated touch sensors to a required pattern of activated touch sensors; and
transmitting, by the portable wireless device, the stored data in response to the detected pattern of activated touch sensors matching the required pattern of activated touch sensors.

2. The method of claim 1, wherein the portable wireless device is a radio frequency identifier (RFID) device, and wherein the interrogation signal is a radio frequency signal.

3. The method of claim 1, wherein the portable wireless device is in an unpowered state prior to receiving the interrogation signal, and wherein the interrogation signal provides power for powering circuitry of the portable wireless device for performing the detecting, comparing, and transmitting operations.

4. The method of claim 1, wherein the required pattern of activated touch sensors comprises a plurality of activated touch sensors less than a total number of touch sensors provided on the portable wireless device.

5. The method of claim 1, wherein all transmissions from the portable wireless device are inhibited by the portable wireless device until the detected pattern of activated touch sensors is determined to match the required pattern of activated touch sensors.

6. The method of claim 1, wherein the touch sensors of the portable wireless device are one of depressable switches, heat sensors, or touch display type sensors.

7. The method of claim 1, wherein the interrogation signal is transmitted by an external reader device configured to read the portable wireless device, and wherein the stored data is data for completing an operation or transaction with the external reader device.

8. The method of claim 1, wherein the stored data is one of a account information, personal identification information, a security code, or an authorization message.

9. The method of claim 1, wherein:
the touch sensors comprise a multi-touch display,
detecting the pattern of activated touch sensors on the portable wireless device comprises detecting a relative positioning of a user's fingertips at locations on the multi-touch display, and
comparing the detected pattern of activated touch sensors to a required pattern of activated touch sensors comprises comparing the detected relative positioning of the user's fingertips on the multi-touch display to a required relative positioning of a user's fingertips.

10. The method of claim 9, wherein the detected relative positioning of the user's fingertips is determined to match the required relative positioning of the user's fingertips in response to the detected relative positioning being within a tolerance of the required relative positioning regardless of the particular portion of the multi-touch display at which the detected relative positioning is detected.

11. A portable wireless device, comprising:
a transceiver;
a plurality of touch sensors; and
comparison logic coupled to plurality of touch sensors and the transceiver, wherein:
the transceiver receives an interrogation signal requesting that the portable wireless device transmit stored data,
the plurality of touch sensors detect, in response to receiving the interrogation signal, a pattern of activated touch sensors on the portable wireless device activated at approximately a same time,
the comparison logic compares the detected pattern of activated touch sensors to a required pattern of activated touch sensors; and
the transceiver transmits the stored data in response to the detected pattern of activated touch sensors matching the required pattern of activated touch sensors.

12. The portable wireless device of claim 11, wherein the portable wireless device is a radio frequency identifier (RFID) device, and wherein the interrogation signal is a radio frequency signal.

13. The portable wireless device of claim 11, wherein the portable wireless device is in an unpowered state prior to receiving the interrogation signal, and wherein the interrogation signal provides power for powering the touch sensors, comparison logic, and transceiver of the portable wireless device for performing the detecting, comparing, and transmitting operations.

14. The portable wireless device of claim 11, wherein the required pattern of activated touch sensors comprises a set of two or more activated touch sensors, less than a total number of touch sensors provided on the portable wireless device.

15. The portable wireless device of claim 11, wherein all transmissions from the portable wireless device are inhibited by the portable wireless device until the detected pattern of activated touch sensors is determined to match the required pattern of activated touch sensors.

16. The portable wireless device of claim 11, wherein the touch sensors of the portable wireless device are one of depressable switches, heat sensors, or touch display type sensors.

17. The portable wireless device of claim 11, wherein the interrogation signal is transmitted by an external reader device configured to read the portable wireless device, and wherein the stored data is data for completing an operation or transaction with the external reader device.

18. The portable wireless device of claim 11, wherein the stored data is one of an account information, personal identification information, a security code, or an authorization message.

19. The portable wireless device of claim 11, wherein:
the plurality of touch sensors comprise a multi-touch display,
detecting the pattern of activated touch sensors on the portable wireless device comprises detecting a relative positioning of a user's fingertips at locations on the multi-touch display, and
comparing the detected pattern of activated touch sensors to a required pattern of activated touch sensors comprises comparing the detected relative positioning of the user's fingertips on the multi-touch display to a required relative positioning of a user's fingertips.

20. The portable wireless device of claim 19, wherein the detected relative positioning of the user's fingertips is determined to match the required relative positioning of the user's fingertips in response to the detected relative positioning being within a tolerance of the required relative positioning regardless of the particular portion of the multi-touch display at which the detected relative positioning is detected.

21. A radio frequency identifier (REID) device, comprising:
an RFID tag mechanism;
a plurality of touch sensors coupled to the RFID tag mechanism; and
comparison logic coupled to the plurality of touch sensors, wherein the RFID tag mechanism receives an interrogation signal requesting that the RFID tag mechanism transmit stored data,
the plurality of touch sensors detect, in response to receiving the interrogation signal, a pattern of activated touch sensors on the RFID device activated at approximately a same time,
the comparison logic compares the detected pattern of activated touch sensors to a required pattern of activated touch sensors; and
the RFID tag mechanism transmits the stored data in response to the detected pattern of activated touch sensors matching the required pattern of activated touch sensors.

22. A computer program product for enabling transmission of stored data from a portable wireless device, the computer program product comprising:
a computer readable storage medium;
first program instructions to receive an interrogation signal requesting that the portable wireless device transmit stored data;
second program instructions to detect, in response to receiving the interrogation signal, a pattern of activated touch sensors on the portable wireless device activated at approximately a same time;
third program instructions to compare the detected pattern of activated touch sensors to a required pattern of activated touch sensors; and
fourth program instructions to transmit the stored data in response to the detected pattern of activated touch sensors matching the required pattern of activated touch sensors, wherein the first, second, third, and fourth program instructions are stored on the computer readable storage medium.
